(19) United States
(12) Patent Application Publication
(10) Pub. No.: US 2008/0091799 A1
(43) Pub. Date: Apr. 17, 2008

(54) Access to Internet Content Via Telephone

(76) Inventor: Ralph J. Weaver, Cary, NC (US)

Correspondence Address: FENWICK & WEST LLP, SILICON VALLEY CENTER, 801 CALIFORNIA STREET, MOUNTAIN VIEW, CA, 94041, US

(21) Appl. No.: 11/549,948

(22) Filed: Oct. 16, 2006

(51) Int. Cl. G06F 15/16

(52) U.S. Cl. 709/218

(57) ABSTRACT

A system and a method to provide access to Internet content via telephone includes a control center that allows a user to select content sources, or modes, via a web browser interface. Once the modes are initially selected, the user calls the control center, is authenticated, and the user cycles through available modes using the telephone keypad. A desired mode is selected, again by keypad, and then items corresponding to that mode are presented to the user. Again using the keypad, the user selects a desired item and the system provides that content as audio to the user.

### BACKGROUND OF THE INVENTION

1. Field of the Invention

This invention relates generally to computer systems and software and more particularly to a system and method of accessing information from the Internet using a standard telephone connection.

2. Description of the Related Arts

Consumers have become so accustomed to obtaining information from the Internet that cellular telephones, personal digital assistants (PDAs) and other devices now often include web browsers and other mechanisms for accessing the Internet. The promise of such devices cannot always be fully realized, however, since there remain a number of places that do not have wireless data service, and the service that is available is sometimes slow in comparison with normal broadband connections.

Further, not all consumers need to access the Internet often enough to justify the expense of a device that includes web browsing capabilities. Still other consumers may have fairly limited needs, such as just checking a news site from time to time.

It would be beneficial for such consumers to be able to access information from the Internet using devices they already have. Data information retrieval using telephones is already available to a limited degree. For example, TellMe Networks, Inc. advertises a service that allows consumers to get information such as news, stock quotes and weather using voice prompts; the website www.fonpods.com advertises a service from Fonpods, LLC that purports to deliver podcasts via a user's telephone. Existing services are not known, however, to provide the consumer with great flexibility in determining which content is to be made available over the telephone.

Therefore, there is a need to have a system and method to allow consumers to select and access content, such as from Internet web sites, directly using their telephones.

### SUMMARY OF THE INVENTION

To address the above, in accordance with the present invention a system and a method uses a standard cellular or wired telephone to navigate and access consumer-selected content from network sources, such as Internet web sites.

In one embodiment, a user accesses a control center via a conventional wired or wireless telephone. A caller ID subsystem identifies the caller as a subscriber and retrieves from the database a record corresponding to the customer's pre-arranged settings and preferences. The customer uses the telephone keypad according to those settings and preferences to select Internet content to be accessed. In response, a network interface subsystem fetches the corresponding content and a voice synthesis subsystem translates text to audio and plays it for the user.

In a related embodiment, a telephone keypad provides the user interface to control access to information. In one embodiment, the “1” key serves as a “mode” control to step the user through predetermined modes of operation (i.e., sources of content), each of which has a corresponding set of audio prompts. The “2” and “5” keys serve as “up” and “down” navigation controls, respectively, to allow the user to navigate within the current mode. The “3” key serves as a “go” control to begin playback of content selected using the mode, up, and down controls, and the “0” key serves as a “stop” control to stop such playback.

In still another embodiment, a user initially sets up operation as described above by visiting a system web site using a conventional computer and web browser, entering identification credentials and then selecting desired content as “favorites,” each selection of which will correspond to one of the modes described above. In a related aspect, the user calls in to the system while browsing a configuration page of the website and watches the navigation among modes on the computer screen in real time to ensure that the user has set up the system as desired.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

The invention has other advantages and features which will be more readily apparent from the following detailed description of a preferred embodiment and the appended claims, when taken in conjunction with the accompanying drawings, in which:

FIG. (“FIG.”) 1 illustrates a system for telephone access to Internet content, in accordance with one embodiment of the present invention.

FIG. 2 illustrates a telephone-based user interface for the system of FIG. 1.

FIG. 3 illustrates audio processing for the system of FIG. 1.

FIG. 4 illustrates architectural interaction among network interface and audio portions of circuitry of the system of FIG. 1.

### DETAILED DESCRIPTION OF THE PREFERRED EMBODIMENTS

The Figures (“FIG.”) and the following description relate to preferred embodiments in accordance with the present invention for purposes of illustration. It should be noted that from the following discussion, alternative embodiments of the structures and methods disclosed herein will be readily recognized as viable alternatives that may be employed without departing from the principles of the claimed invention.

Referring now to FIG. 1, an Internet content access system 10 includes a control center 100 coupled with a conventional telephone 110. For purposes of discussion here, telephone 110 can be any sort of telephone with a touch-tone keypad or other tone generating capability, such as a wired phone, a wireless home phone or a cell phone. It is anticipated that in many applications, cell phone usage will be most common since it is assumed that the system 10 primarily will be used from locations where a computer is otherwise not available. In some embodiments, conventional Internet protocols (e.g., Simple Object Access Protocol) provide additional mechanisms for control of system 10, for example where 3G cell phones provide the user with such mechanisms.

The primary components of control center 100 are a Caller ID subsystem 102, a database subsystem 104, a network interface subsystem 106, and a voice synthesis subsystem 108. In operation Caller ID subsystem 102 uses conventional telephone company-provided caller identification information to automatically identify a subscriber who is calling in to control center 100. In some embodiments, additional credential verification, such as passwords, is used to identify subscribers. In particular, password identification capability may be desired to allow a subscriber to call in from a phone other than one registered for use with system 10 (e.g., a pay phone at an airport).

Database subsystem 104 stores all of the subscriber-related information used by control center 100. FIG. 1 shows database subsystem 104 as being within control center 100, but in other embodiments the database could be kept remotely and control center 100 can access it through a network connection.

Network interface 106 is configured with conventional circuitry and software that connects control center 100 to the Internet to access information as requested by users. For example, if a user configuration includes information from www.uspto.gov, network interface 106 connects to that site and collects information from that site.

Voice synthesis subsystem 108 is implemented using conventional voice synthesis hardware/software that converts textual and other information obtained from the Internet via network interface 106 to audio for transmission to the user's telephone 110. In some cases, subsystem 108 converts non-text information to audio; for example subsystem 108 converts audio files (e.g., MP3 or WMA files) files into a format such as uLaw audio to stream such audio to a user's telephone.

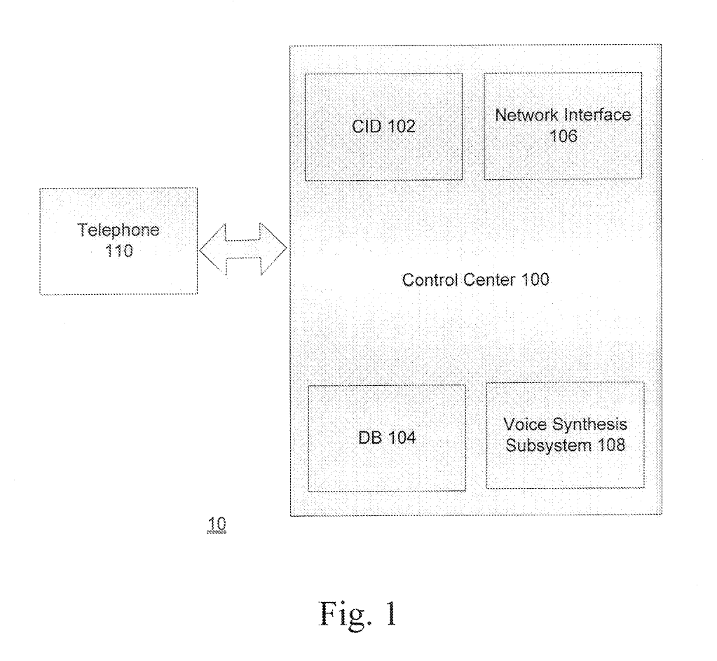

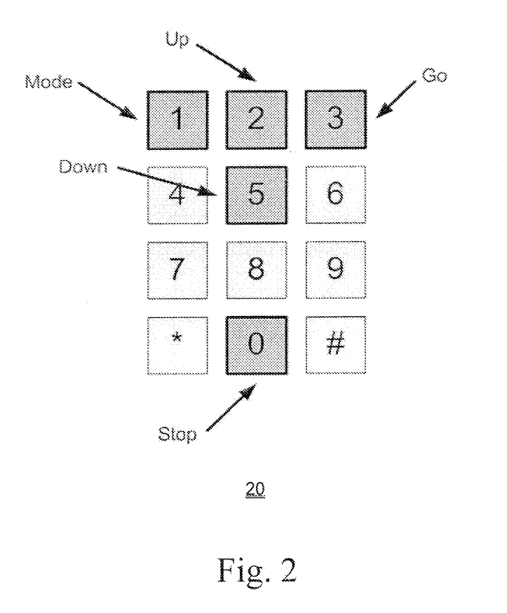

Referring now to FIG. 2, a telephone keypad-implemented user interface 20 for system 10 is shown. In this embodiment, access to content uses conventional DTMF tones from a conventional telephone keypad. Specifically, the “1” key on the telephone keypad is used to select among various user-configured “modes” of operation. The “2” and “5” keys, respectively, are used for “up” and “down” navigation among item choices corresponding to each mode. The “3” key is used as a “go” key to commence playback of selected content, and the “0” key is used as a “stop” key to stop playback of such content. As noted above, conventional devices such as 3G phones may permit other mechanisms such as SOAP control, to be used in alternate embodiments in addition to, or instead of, DTMF tones.

In operation, after initial configuration a user calls control center 100 via telephone 110, is automatically authenticated via caller ID subsystem 102, and is presented with an audio message indicating that such authentication has been completed. The user then presses the “mode” (“1”) key on the phone, and in response control center 100 provides audio information identifying a first one of the user's preselected content sources. Subsequent presses of the “mode” key cycle the user through all of the user's preselected content sources. Upon hearing the desired source (e.g., “National News”), the user presses the “down” key, which causes control center 100 to begin listing the items (or “topics,” e.g., individual news headlines) that are available from that source. If the user finds an item of interest, the user presses the “go” key and begins to hear the content under that item (e.g., the news article corresponding to the selected headline). If the user has gone past a desired item, the user can press the “up” key to get back to it. If the user has heard enough of an item, the user presses the “stop” key to return to the list of available items at the same location as before, or the “mode” key to stop playback and take the user to the start of the mode. If a new mode is desired, the user presses the “mode” key to continue cycling among modes. In an alternate embodiment, mode selection is made via separate mode-forward and mode-backward keys rather than a single mode key.

A user initially configures system 10 by accessing a web site that corresponds to control center 100 and logging on using conventional password authentication. Once authenticated, the user selects a number of web sources to correspond to each of a number of “modes” that are to be accessible via the telephone interface. While the discussion above centered on Internet web site content, other types of content could be selected as well. For example, a user might select an RSS (Really Simple Syndication) national news feed such as Fox National News provided at www.foxnews.com as one mode, a world news RSS feed as a second mode, and so on. In a preferred embodiment, it is up to the user to determine how many modes are manageable using the navigation interface as discussed above in connection with FIG. 2. Likewise, the user can select not only among RSS feeds, but web sites, FTP servers, WebDev Servers as public content sources, as well as private sources such as proprietary servers (e.g., SOAP, Corba). In many instances, the selected content will be text-based, whether in HTML, plain text or similar format. In other instances, audio or other file types may be selected as well.

In some embodiments, system 10 is adapted to allow content sources to be nested within user-named modes (similar to tabs in a notebook), which provides users with flexibility to arrange the content sources in ways they find most helpful and efficient. For example, a first user might have a “news” mode with three news sources, while a second one might have those same sources set up as un-nested modes (i.e., in “flat” fashion), as illustrated here:

```
USER 1
News
    Source 1
        Story 1
        Story 2
        Story 3
    Source 2
        Story 1
        Story 2
    Source 3
        Story 1
        Story 2
        Story 3
        Story 4
Sports
    Source 4
        Story 1
        Story 2
        Story 3
        Story 4
    Source 5
        Story 1
        Story 2
        Story 3
USER 2
Source 1
    Story 1
    Story 2
    Story 3
Source 2
    Story 1
    Story 2
Source 3
    Story 1
    Story 2
    Story 3
    Story 4
Source 4
    Story 1
    Story 2
    Story 3
    Story 4
Source 5
    Story 1
    Story 2
    Story 3
```

Selection of a mode typically gives rise to a number of sub-choices relating to that mode. For instance, selection of an RSS news feed typically results in presentation of a number of headline links. In these situations, it is obvious what items are to be presented to the user when the corresponding mode is selected. In other situations, such as selection of a corporate website, there may be a mixture of second-level links and plain text on the primary page for a selected mode. Database 104 is configured to deal with such instances by running a script that automatically selects what items are presented to the user when in that mode. For example, a corporate website may include a number of links such as “products,” “about the company” and “contact us” in addition to having several textual portions directly on the home page. The script will select which of those are presented by system 10, using conventional data mining analysis of the content. In an alternate embodiment, the user is permitted to select which items to include manually, and control center 100 then directs database subsystem 104 to generate a corresponding script for future retrieval of information in this mode.

Once the user has configured system 10 and identified the “modes” that are to be made available, database 104 saves that information. In a preferred embodiment, system 10 is configured so that the user can test operation of selected modes by watching a conventional menu display of the user's navigation directly from the configuration web page. For instance, the user can call the access number and watch a menu representation of the system presenting the selected modes and stepping through the choices available for each selected mode. In one embodiment, a pointer is displayed corresponding to the user's current location, and as the user navigates among modes and among items within modes, the pointer moves in a corresponding manner. This permits the user to visually understand how the user's navigation is progressing, thereby making it easier for the user to visualize such navigation later when a computer is not available.

Control center 100 decodes the user's selection of modes and other navigation commands through conventional DTMF decoding, and based on information stored in database 104 directs network interface 106 to fetch the requested content from the appropriate network source (e.g., the specified Internet web site corresponding to the selected mode). Once network interface 106 retrieves this information, if it is not already in an audio format, a conventional voice synthesis subsystem 108 converts the context from its native form (e.g., text) to voice audio, and control center 100 then sends the audio stream to the user's telephone 110. If the information is already in an audio format such as MP3, it converts it into an audio format suitable for streaming, such as uLaw. In alternate embodiments, different conventional codecs such as aLaw and ADPCM are also usable to facilitate streaming.

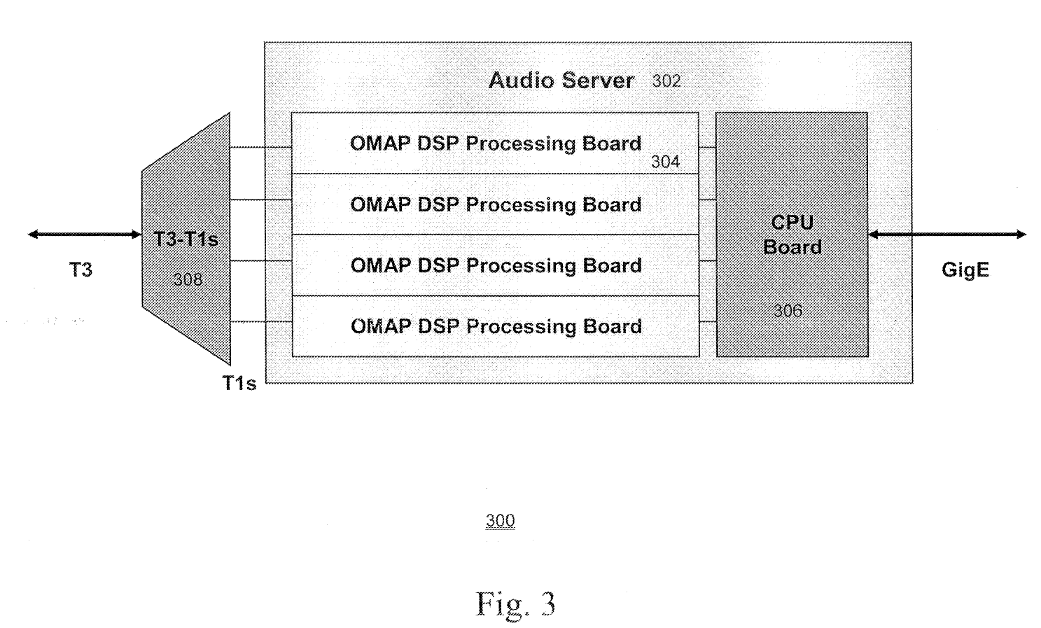

Referring now to FIG. 3, circuitry 300 is shown for processing network data and audio as described above. An audio server 302 includes digital signal processing circuits, e.g., DSP boards including the OMAP™ technology provided by Texas Instruments, and a conventional central processing unit 306 to control them. In alternate embodiments, other conventional processing components, circuitry and software are used, such as a programmed microcontroller, microprocessor or DSP processing board. Audio Server 302 connects to the desired content source via network interface 106 using, in a preferred embodiment, a large bandwidth connection such as a 100 Mbps or gigabit Ethernet connection, to allow a large number of concurrent connections. Likewise, the converted audio version of each source of content is sent via high speed (e.g., T1) connections, which may be consolidated using subsystem 308 into a T3 connection, for downstream processing into audio transmitted concurrently to a number of users' telephones.

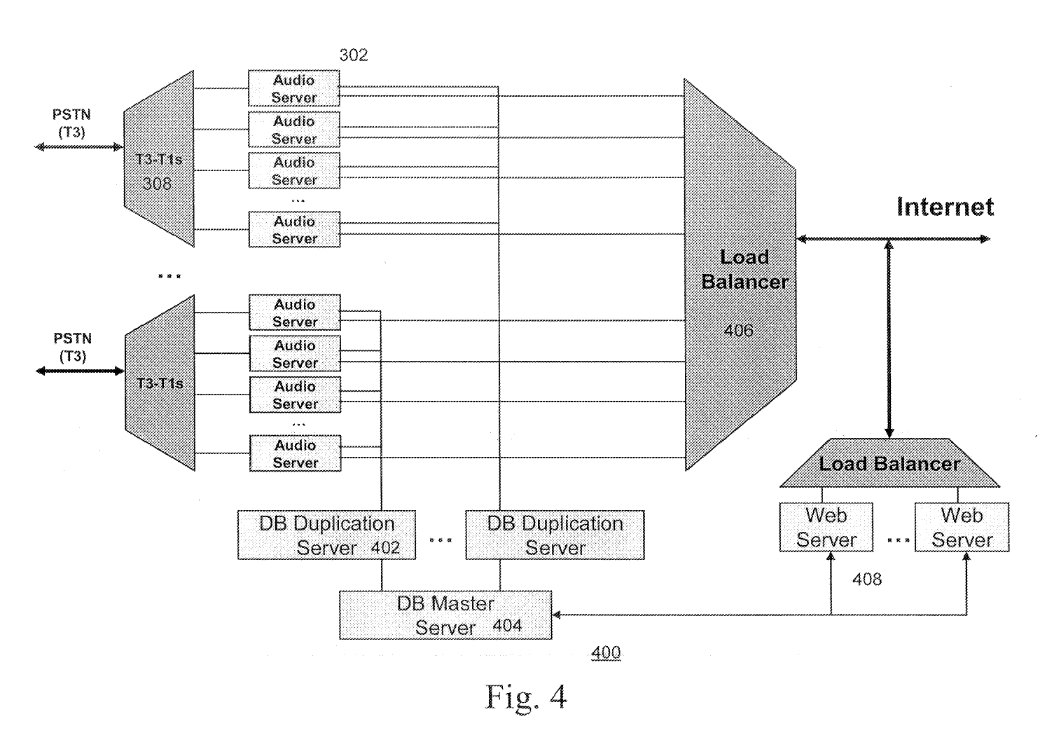

Referring now to FIG. 4, in a preferred embodiment scaling of system 10 is achieved by circuitry 400 that permits database system 104, network interface system 106 and voice synthesis system 110 to handle a large number of concurrent users. In the embodiment shown in FIG. 4, a number of audio servers 302 have outputs consolidated by subsystems 308 for playback of audio on users' individual PSTN telephone connections. In the example shown in FIG. 4, system reliability is enhanced by using duplicated database servers 402 under control of a master database server 404. Circuitry 404 obtains Internet content through load balancers 406 that manage both audio servers 302 and web servers 408, again to ensure that large numbers of multiple users can be handled concurrently.

In a preferred embodiment, content to be accessed by a user is obtained over the Internet in real time, i.e., as a user requests it. In some embodiments, it may be beneficial to cache data that is likely to be requested by one or more users so as to further provide scaling and bandwidth benefits. For instance, if a user has selected a particular mode, circuitry 400 may access not only the list of items available via that mode, but also all of the underlying content corresponding to each of the listed items, so that if a user selects an item the content is immediately available. In other instances, historically certain sources may be so popular among users that it can be anticipated that data from those sources will be needed, and it can be obtained periodically whenever bandwidth is available so that it is immediately accessible when requested.

Upon reading this disclosure, those of skill in the art will appreciate still additional alternative structural and functional designs for a system and a process for providing access to Internet content via telephone through the disclosed principles and examples above. Thus, while particular embodiments and applications of the present invention have been illustrated and described, it is to be understood that the invention is not limited to the precise construction and components disclosed herein and that various modifications, changes and variations which will be apparent to those skilled in the art may be made in the arrangement, operation and details of the method and apparatus of the present invention disclosed herein without departing from the spirit and scope of the invention as defined in the appended claims.

What is claimed is:

1. A method of accessing content from a network using a telephone, comprising:
configuring a control center to provide a plurality of modes, each of said modes corresponding to a content source;
accessing the control center via a telephone call, wherein the control center authenticates a user;
cycling among the plurality of modes using a first one of a set of keys on a telephone keypad, the control center providing voice identification of each of the plurality of modes;
selecting one of the modes using a second one of the set of keys;
cycling among a plurality of items responsive to selecting one of the modes;
selecting one of the items using a third one of the set of keys; and
sending audio, corresponding to the content, to the telephone responsive to selecting one of the items.

2. The method of claim 1, further comprising:
obtaining the content from the network responsive to selecting one of the items.

3. The method of claim 1, further comprising:
obtaining the content from the network responsive to selecting one of the modes.

4. The method of claim 1, wherein the audio, corresponding to the content, is an audio stream generated from the content.

5. The method of claim 1, wherein the first one of a set of keys is a “1” key, the second one of the set of keys is a “5” key, and the third one of the set of keys is a “3” key.

6. A system for accessing content from a network using a telephone, the system comprising:
an authentication subsystem to identify a caller as an authorized user;
a database subsystem operatively coupled to the authentication subsystem and configured to store a plurality of modes chosen by the authorized user;
a network interface subsystem coupled to the database subsystem and configured to access content corresponding to said modes; and
an audio synthesis subsystem coupled to the network interface to send to the telephone audio corresponding to the content, responsive to the authorized user selecting one of said modes.

7. The system of claim 6, wherein the audio synthesis subsystem is configured to provide the authorized user with voice prompts corresponding to each of said modes.

8. The system of claim 6, wherein a plurality of items correspond to each mode, wherein the audio synthesis subsystem is configured to provide the authorized user with voice prompts corresponding to each of the plurality of items and to provide the audio corresponding to the content in response to the authorized user's selection of one of the plurality of items.

9. The system of claim 6, wherein the system is configured to respond to DTMF control by the user.

10. The system of claim 6, wherein the system is configured to cycle the authorized user through said modes responsive to the authorized user repeatedly pressing a “1” key on the telephone.

11. The system of claim 8, wherein the system is configured to provide the authorized user with the voice prompts corresponding to each of the plurality of items responsive to the authorized user repeatedly pressing a “5” key on the telephone.

12. The system of claim 11, wherein the system is configured to provide the authorized user with the audio corresponding to the content responsive to the authorized user pressing a “3” key on the telephone after hearing one of the voice prompts corresponding to each of the plurality of items.

13. The system of claim 6, wherein the database subsystem includes a web browser interface for initial selection of the modes by the authorized user.

14. A method of remotely navigating within a network using a telephone, the telephone having certain keys designated for navigation, comprising:
configuring a control center to provide a plurality of modes, each of said modes corresponding to a content source;
accessing the control center via a telephone call; and
displaying a user's location in the network in response to the user actuating at least one of the keys designated for navigation.

15. A method as in claim 14, wherein the keys designated for navigation are keys on a dial pad of the telephone, the method further comprising decoding tones corresponding to said user actuating at least one of the keys designated for navigation.
